(19) United States
(12) Patent Application Publication
(10) Pub. No.: US 2016/0233679 A1
(43) Pub. Date: Aug. 11, 2016

(54) A METHOD AND SYSTEM FOR CONTROL OF SMOOTHING THE ENERGY STORAGE IN WIND PHTOVOLATIC POWER FLUCTUATION BASED ON CHANGING RATE

(71) Applicants: CHINA ELECTRIC POWER RESEARCH INSTITUTE, Beijing (CN); STATE GRID CORPORATION OF CHINA, Beijing (CN)

(72) Inventors: Xiangjun Li, Beijing (CN); Dong Hui, Beijing (CN); Xiaokang Lai, Beijing (CN)

(73) Assignees: STATE GRID CORPORATION OF CHINA, Beijing (CN); CHINA ELECTRIC POWER RESEARCH INSTITUTE, Beijing (CN)

(21) Appl. No.: 14/123,516

(22) PCT Filed: Oct. 18, 2013
(86) PCT No.: PCT/CN2013/085436

§ 371 Date: Dec. 3, 2013

(51) Int. Cl. H02J 3/32; F03D 7/04; G05B 17/02; H02S 10/00

(52) U.S. Cl. CPC H02J 3/32; H02S 10/00; F03D 7/042; G05B 17/02

(57) ABSTRACT

The invention relates to a method and system for smoothing the energy storage wind and photovoltaic power fluctuation based on rate control, including: reading and processing data; determining the signal change rate of the dynamic slope limiter; calculating the smoothing target value of the wind and photovoltaic total power; calculating total power demand of battery energy storage power station; and outputting data. The invention can effectively suppress wind and photovoltaic power fluctuation under the fluctuation rate limited value, can effectively smooth wind and photovoltaic power output. Thus it smoothens wind and photovoltaic power output, reduces the energy storage battery burden, and effectively controls battery energy storage power station system.

### RELATED APPLICATIONS

This application is a United States National Stage Application filed under 35 U.S.C 371 of PCT Patent Application Serial No. PCT/CN2013/085436, filed Oct. 18, 2013, the disclosure of all of which are hereby incorporated by reference in their entirety.

### FIELD OF THE INVENTION

The invention relates to the smart grid and energy storage and conversion technical field. In particular, it relates to a control method of the smoothing wind and photovoltaic power output of the large power energy storage system, which is suitable for the smoothing wind and photovoltaic and energy storage power output and the battery real-time power calculation of a MW-scale energy storage power station.

### BACKGROUND OF THE INVENTION

Due to the uncertainty and instability of the wind and photovoltaic power generation, instantaneous power fluctuation will cause the unstable output power, and lead to wind and photovoltaic grid power fluctuate. Moreover, with the increased popularity in the power grid, the output smoothing control of wind and photovoltaic power generation attracts more and more attention.

With the continuous development of battery and integrated technology, using battery energy storage power station to smooth the output power of wind and photovoltaic power generation has become feasible. Through the reasonable control to the converter connected with the energy storage equipment, and efficient implementation of the charging and discharging of the energy storage system, the wind and photovoltaic output power instability problem can be largely solved which is caused by wind power and photovoltaic power generation of random, intermittent and fluctuation, in order to satisfy the smooth output of the wind and solar power generation requirements, and effectively solve the power quality problems like the grid frequency fluctuation caused by wind and photovoltaic power fluctuation. Wind and photovoltaic and energy storage power generation system is essentially a multi energy system, how to coordinate the power supply system is a key problem of multi energy generation system. For the battery, over charging and over discharge both impact battery life. Therefore, it is necessary to monitor the state of charge of the battery (SOC) and control the state of charge of battery within a certain range. Moreover, in the hybrid photovoltaic and wind and energy storage power generation system, if the storage battery remaining power is not monitored by a reasonable and effective control strategy, it will add unnecessary battery capacity and use cost.

Battery energy storage power station can smooth wind and photovoltaic power according to the requirement of smoothing wind and photovoltaic power generation output and the remaining capacity SOC of energy storage battery. Therefore, it is necessary to propose and study the control method of wind and photovoltaic and energy storage power generation system. At present, the technologies are limited in the wind and photovoltaic power output control method of the MW scale high-power high-capacity battery energy storage power station, which requires further research and exploration.

### BRIEF DESCRIPTION OF THE DRAWINGS

FIG. 1 is a structure schematic diagram of hybrid wind and photovoltaic and energy storage power generation system provided by the invention;

FIG. 2 is an implementation block diagram of smoothing wind and photovoltaic power output fluctuation based on the dynamic slope limiter of battery energy storage power station provided by the invention;

FIG. 3 is a control effect schematic diagram of smoothing wind and photovoltaic output power fluctuation based on energy storage power station provided by the invention;

FIG. 4 is a fluctuation rate suppression effect schematic diagram of smoothing wind and photovoltaic output power fluctuation based on energy storage power station provided by the invention;

FIG. 5 is a control effect schematic diagram of smoothing photovoltaic output power fluctuation in one day based on energy storage power station provided by the invention;

FIG. 6 is a fluctuation rate suppression effect schematic diagram of smoothing photovoltaic output power fluctuation in one day based on energy storage power station provided by the invention.

### SUMMARY OF THE INVENTION

In view of the above problems, one objective of the invention is to provide a control system and method to suppress wind and photovoltaic power output fluctuation, effectively reduce use rate of battery energy storage power plant, and prolong the battery energy storage power station service life.

The control method of the invention is realized through the following technical scheme:

A method and system for control smoothing the energy storage wind and photovoltaic power fluctuation control of based on change rate includes steps as below:

A, reading the relevant data of wind and photovoltaic power plant and battery energy storage power station, and save data, said wind and photovoltaic power plant consists of synchronized wind power generation units and photovoltaic units;

B, determining the variability limited value of the wind and photovoltaic total power real timely;

C, calculating smoothing target value of the wind and photovoltaic total power real timely;

D, computing the total power demand value of the battery energy storage power plant real timely; and

E, outputting the real time total power demand value of the battery energy storage power plant calculated in step D and the smoothing target value of the wind and photovoltaic total power calculated in step C.

Furthermore, in said step A, the said relevant data include: wind and photovoltaic power output fluctuation rate limited value, wind power, photovoltaic power, operation state values and rated power values of each wind unit in the wind power plant, operation state values and rated power values of each wind unit in the photovoltaic power plant, and maximum allowable charging power and the maximum allowable discharge power of the battery energy storage station.

Furthermore, said step B includes specific steps:

B1) calculating current total rated power of wind and photovoltaic power generation units connected into grid, namely the wind and photovoltaic total rated power;

B2) through the wind and photovoltaic total rated power, calculating the change rate limited value of wind and photovoltaic total power.

Furthermore, said step C includes the following specific steps:

C1) the first sampled wind and photovoltaic total power value, which is input the dynamic slope limiter module, is set to the initial power output P^{RL}_{w/p total}(l) after change rate limited:

C2) the current sampling time change rate of wind and photovoltaic total power value is computed based on below formulation:

$${r}_{rate}^{w / p total} ( t ) = \frac{{P}_{w / p total} ( t ) - {P}_{w / p total} ( t - 1 )}{Δ t} ( t \geq 2 )$$

In above formulation, P_{w/p total}(t), P_{w/p total}(t−1) are the wind and photovoltaic total power at the current sampling time t and the last sampling time of t−1, respectively; said wind and photovoltaic total power is equal to the sum of the wind power and photovoltaic power; Δt is the sampling interval of wind and photovoltaic total power value;

C3) the judgment is made according to change rate limit condition, until get the power output P^{RL}_{w/p total}(t) after change rate limited at current sampling time; saving each power output after change rate limited for the next sampling time judgment;

C4) the current output power P^{RL}_{w/p total}(t) after change rate limited is set as the current wind and photovoltaic total power smoothing target value P^{smooth target}_{w/p total} (t), i.e. P^{smooh target}_{w/p total} (t)=P^{RL}_{w/p total}(t).

Furthermore, the specific step of said step D includes:

D1) taking the difference between the current sampling time output power P^{RL}_{w/p total}(t) got from step C and current sampling time wind and photovoltaic total power value P_{w/p total}(t) as the total power real-time demand P_{energy storage total}(t) of battery energy storage station of the current sampling time t;

D2) according to current sampling time t, the maximum allowed charge and discharge power of the battery station, correcting the current total power real-time demand P_{energy storage total}(t) of battery energy storage station.

Furthermore, in said step E, sending the real time power demand value of the battery energy storage power plant calculated in step D and the smoothing target value of the wind and photovoltaic total power calculated in step C to the communication module, and then the communication module outputting it to the external monitor platform to perform the power control of the battery energy storage station, at the same time to smooth the wind and photovoltaic total power output.

Another objective of the invention is to provide a system for smoothing the energy storage wind and photovoltaic power fluctuation control of based on change rate, the system includes:

The communication module that is used for data receiving the relevant data of wind and photovoltaic power plant and battery energy storage power station, and data transmission and communication with external monitoring platform;

The data storage and management module that is used for data storage and management of wind and photovoltaic power plant and battery energy storage power station; and sending the smoothing target value of the wind and photovoltaic total power calculated and real time total power demand value of the battery energy storage power station to the external monitoring platform:

The limited change rate calculation module that is used for determining real time change rate limited value of wind and photovoltaic total power, and send to the dynamic slope iimiter module;

The dynamic slope limiter module that is used for calculating real-time smoothing target value of the wind and photovoltaic total power; and

The power distribution controller module, which is used for real-time calculation of real-time total power demand value of battery energy storage power station;

Compared with the prior art, the invention has following advantages:

The invention provides a method and system for smoothing the energy storage wind and photovoltaic power fluctuation control of based on change rate, the method and the system are mainly based on wind and photovoltaic power fluctuation rate limit and dynamic slope Iimiter module, to calculate total power smoothing target value and energy storage power station total power demand value. It stabilize the wind and photovoltaic power fluctuation according to synchronize power demand, only when the fluctuation rate against the wind and photovoltaic power synchronizing constraints, it can smooth wind and photovoltaic power fluctuations through the energy storage system; Thus it not only inhibits wind and photovoltaic power output fluctuations, but also reduces the use rate of battery energy storage power plant effectively, and prolongs the service life of battery energy storage power station and other benefits.

### DETAILED DESCRIPTION OF EMBODIMENTS

The detail of the embodiments is described as below incorporated with the figures by way of cross-reference for the present invention. According to some embodiments, the lithium-ion battery energy storage power station is used as an example.

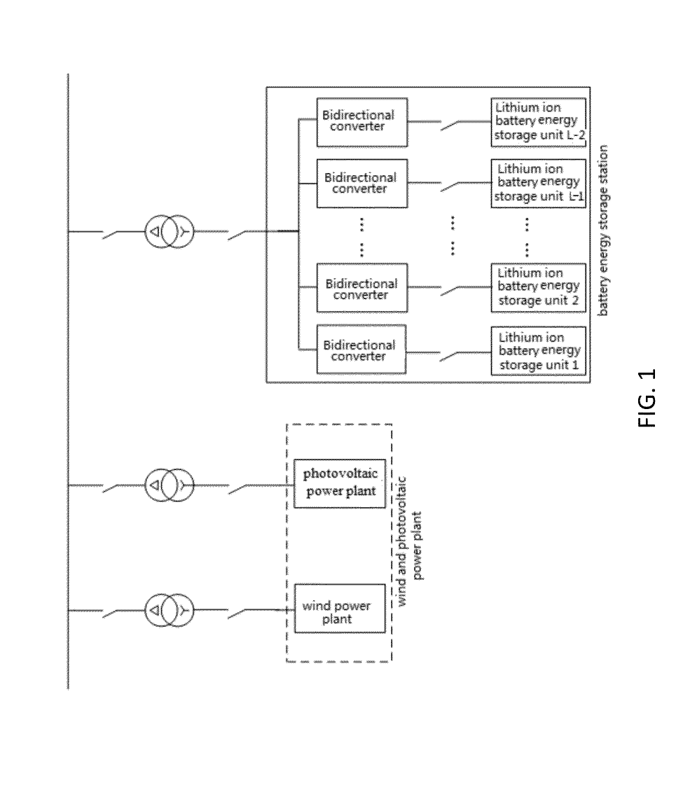

As shown in FIG. 1, a hybrid photovoltaic and wind and energy storage power generation system includes a wind and photovoltaic power piant (for short, wind power plant and photovoltaic power plant), a battery energy storage power station and a power grid; wind power plant, photovoltaic power plant and battery energy storage power station are connected with power grid through transformer. Wind power plant has a plurality of wind power generation units, each one among which is connected with transformer through a converter; The photovoltaic power plant has a plurality of photovoltaic power units, each unit are respectively connected with transformer through a converter; The wind and photovoltaic power generation units adopt parallel connected mode, the wind and photovoltaic power plant internal connection diagrams are omitted here. Each lithium ion battery of Battery energy storage power station is connected with the bidirectional converter.

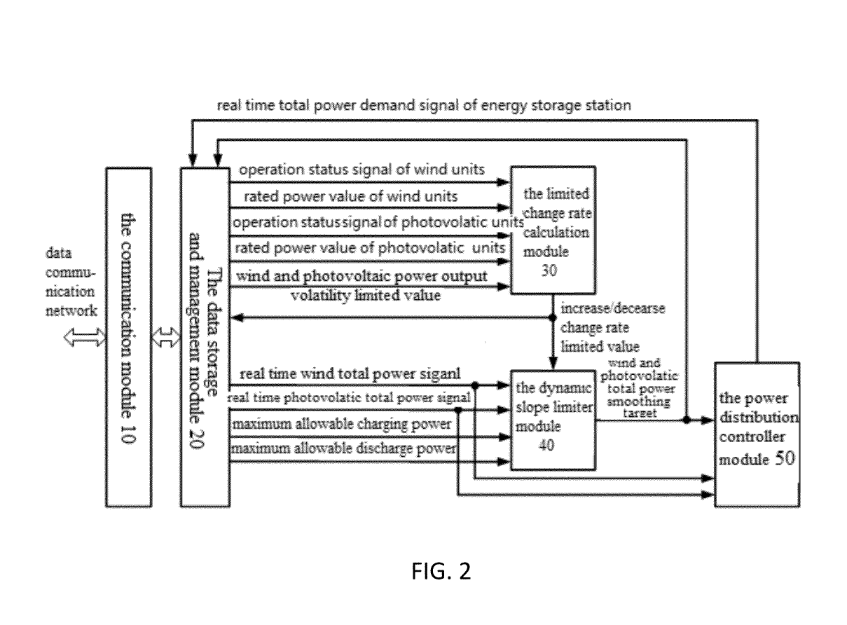

FIG. 2 is an implementation block diagram of smoothing wind and photovoltaic power output fluctuation based on the dynamic slope limiter of battery energy storage power station provided by the invention. As shown in FIG. 2, the invention is achieved by the communication module 10, the data storage and management module 20, the limited change rate calculation module 30, the dynamic slope limiter module 40 and the power distribution controller module 50 arranged in the industry personal computer (IPC).

The communication module 10 receives wind power plant, photovoltaic power plant and battery energy storage power station operation data, and sends wind and photovoltaic total power smoothing target value and battery energy storage unit power command value to the external monitoring platform, the monitoring platform is arranged at the left side of the communication module, and connected with the communication module to monitor and control the communication modules.

The data storage and management module 20 is used to store and manage the wind power plant, photovoltaic power plant relevant data and battery energy storage real-time operation data and historical data; and it is also responsible for sending the calculated wind and photovoltaic total power smoothing target value and energy storage power station total power demand value to the relevant the interface variables according to set protocol for the external monitoring system call;

The limited change rate calculation module 30 is used for determining real time change rate limited value (the rise/fall rate limited value the dynamic slope limiter modules needs) of wind and photovoltaic total power, and send to the dynamic slope limiter module;

The dynamic slope limiter module 40 is used for calculating real-time smoothing target value of the wind and photovoltaic total power; and

The power distribution controller module 50 is used for real-time calculation of real-time total power demand value of battery energy storage power station.

A method and system for smoothing the energy storage wind and photovoltaic power fluctuation control based on change rate provided by the invention includes steps as below:

Step A. reading the relevant data of wind and photovoltaic power plant and battery energy storage power station through communication module 10, which includes the total power of wind power generation and photovoltaic power generation, operation state values of power values of each wind unit in the wind power plant, rated output of each wind unit in the wind power plant, operation state value of photovoltaic power plant, rate power value of photovoltaic power plant, fluctuation rate limited value of wind and photovoltaic power plant, and maximum allowable charging power the maximum allowable discharge power of the battery energy storage station, and then sending the above data to the data storage and the management module 20 to store and managing the data.

Step B. According to the current operation wind and photovoltaic rated total power and wind and photovoltaic power fluctuation rate limited value, to real-time calculate the change rate limited value of wind and photovoltaic total power (i.e.: the rise/fall rate limited value the dynamic slope Iimiter modules needs).

Step C: Firstly, calculate the change rate of the of wind and photovoltaic total power, then according to the change rate limiting conditions to determine the output power after the change rate limitation; Secondly, the output power after the change rate limitation is set as the current moment smoothing target value of wind and photovoltaic total power.

Step D: Energy storage power plant real-time demand value is calculated based on the power distribution controller module. That is, the difference between the output value of the dynamic slope Iimiter difference and the wind and photovoltaic total power is considered as the real-time demand power of the energy storage station.

Step E: Sending the real time total power demand value of the battery energy storage power plant calculated in step D and the smoothing target value of the wind and photovoltaic total power calculated in step C to the communication module, and then the communication module output it to the external monitor platform to perform the power control of the battery energy storage station, at the same time to smooth the wind and photovoltaic total power output.

The specific steps of B are as follows:

B1) Based on operation state signals and rated power value of the wind power units, the operation state signals and rated power value of the photovoltaic power units, the wind and photovoltaic total rated power is calculated through below formulation (1):

$${P}_{w / p total}^{rated} = {\sum }_{k = 1}^{W} {u}_{wind k} {P}_{wind k}^{rated} + {\sum }_{k = 1}^{W} {u}_{photovolatic k} {P}_{photovolatic k}^{rated} \qquad ( 1 )$$

In which, P^{rated}_{wind k} is the rated power of the wind unit k: u_{wind k} is the operation status value of the wind unit k, when the unit k is controllable operation, the operate value is equal to 1, or it is 0; P^{rated}_{photovolatic k} is rated power of the photovoltaic unit k; u_{photovolatic k} is the operation status value of the photovoltaic unit k, when the unit k is controllable operation, the value is equal to 1, or it is 0; data above all are read through step A; W is the number of the wind units; and V is the number of the photovoltaic units.

B2) Based on the current operation wind and photovoltaic rated total power and wind and photovoltaic power fluctuation rate limited value, to real-time calculate the limiting sign change rate demanded of the dynamic slope limiter. That is, the increase/decrease rate limited values are calculated according to below formulations (2) and (3), respectively:

$$\begin{matrix}{k}_{rate}^{increase} = \frac{{P}_{w / p total}^{rated} \times {r}_{fluctuation rate}^{limited}}{{T}_{time}} & ( 2 ) \\ {k}_{rate}^{decrease} = \frac{{P}_{w / p total}^{rated} \times {r}_{fluctuation rate}^{limited}}{{T}_{time}} & ( 3 )\end{matrix}$$

In which, k^{increase}ᵣₐₜₑ is the increasing change rate limited value of input sign of the dynamic slope limiter; k^{decrease}ᵣₐₜₑ is the decreasing change rate value of the dynamic slope limiter; r^{limited}_{fluctuation rate} is fluctuation rate limited value of wind and photovoltaic power, the value is read from step A; Tₜᵢₘₑ is the time interval of the change rate.

For example, the current wind and photovoltaic power unit rated total power is 100 MW (100×1000=100000 kW), wind power fluctuation rate limited value is 7%/15 min, the time interval of the change rate Tₜᵢₘₑ is set to 15 minutes, that is 15×60=900 seconds (s), the increase/decrease rate limit values are calculated as follows:

$$\begin{matrix}{k}_{rate}^{increase} = \frac{{P}_{w / p total}^{rated} \times {r}_{fluctuation rate}^{limited}}{{T}_{time}} = \frac{( 100 \times 1000 \times 0.07 ) kW}{( 15 \times 60 ) s} = 7.7 kW \text{/} s & ( 4 ) \\ {k}_{rate}^{decrease} = - \frac{{P}_{w / p total}^{rated} \times {r}_{fluctuation rate}^{limited}}{{T}_{time}} = - \frac{( 100 \times 1000 \times 0.07 ) kW}{( 15 \times 60 ) s} = - 7.7 kW \text{/} s & ( 5 )\end{matrix}$$

The specific steps of C are as follows:

C1) the first sampled wind and photovoltaic total power value, which is input the dynamic slope limiter module, is set to the initial (t=1) power output P^{RL}_{w/p total}(l) after rate limiter;

P^{RL}_{w/p total}(l)=P_{w/p total}(l) (6)

r^{w/p total}ᵣₐₜₑ(l)=0 (7)

C2) said dynamic slope limiter module calculates the current sampling time t change rate of wind and photovoltaic total power value based on below formulation:

$${r}_{rate}^{w / p total} ( t ) = \frac{{P}_{w / p total} ( t ) - {P}_{w / p total} ( t - 1 )}{Δ t} ( t \geq 2 ) \qquad ( 8 )$$

In formulation (8), P_{w/p total}(t) is the wind and photovoltaic total power (Unit: kW) at the current sampling time t, The wind and photovoltaic value is equal to the sum of the wind power and photovoltaic power at sampling time t, and the wind power and photovoltaic power value is got through the steps of A (communication module); P_{w/p total}(t−1) are the wind and photovoltaic total power (Unit: kW) at the pervious sampling time t−1; said wind and photovoltaic total power is equal to the sum of the wind power and photovoltaic power; Δt is the sampling interval of the limited signal (wind and photovoltaic total power value);

For example, the wind and photovoltaic total power value at current sampling time t is 10050 kW, the wind and photovoltaic total power value at previous sampling time (t−1) is 10000 kW, the sampling interval of the limited signal (wind and photovoltaic total power value) is 5 seconds, the calculation results the change rate of wind and photovoltaic total power is as follow:

$${r}_{rate}^{w / p total} ( t ) = \frac{{P}_{w / p total} ( t ) \times {P}_{w / p total} ( t - 1 )}{Δ t} = \frac{( 10050 - 10000 ) kW}{5 s} = 50 kW \text{/} 5 s \qquad ( 9 )$$

C3) the judgment is made according to change rate limit condition, until get the power output P^{RL}_{w/p total}(t) after rate limiter at current sampling time; save each power output after rate limiter for the next sampling time judgment; the specific judgment method according to said change rate limit condition is:

If k^{decrease}ᵣₐₜₑ≦r^{w/p total}ᵣₐₜₑ(t)≦k^{increase}ᵣₐₜₑ, the output power P^{RL}_{w/p total}(t)=P_{w/p total}(t) (10)

If r^{w/p total}ᵣₐₜₑ(t)>k^{increase}ᵣₐₜₑ, the output power P^{RL}_{w/p total}(t)=P^{RL}_{w/ptotal}(t−1)+Δt×k^{increase}ᵣₐₜₑ (11)

If r^{w/p total}ᵣₐₜₑ(t)<k^{decrease}ᵣₐₜₑ, the output power P^{RL}_{w/p total}(t)=P^{RL}_{w/p total}(t−1)+Δt×k^{decrease}ᵣₐₜₑ (12)

In which, P^{RL}_{w/p total}(t) is the power output of dynamic slope limiter module after rate Iimiter at current sampling time t; P^{RL}_{w/p total}(t−1) is the power output of

dynamic slope Iimiter module after rate Iimiter at previous sampling time; Δt is the sampling period between two adjacent sampling time (the sampling interval), it is 5S in this example.

C4) the current output power P^{RL}_{w/p total}(t) after rate limiter is set as the current wind and photovoltaic total power smoothing target value P^{smooth target}_{w/p total}(t), i.e. P^{smooh target}_{w/p total}(t)=P^{RL}_{w/p total}(t).

The specific steps of D are as follows:

D1) Based on the difference between the current sampling time (sampling time t) output power P^{RL}_{w/p total}(t) got from step C and current sampling time (sampling time t) wind and photovoltaic total power value P_{w/p total}(t), the current sampling time (sampling time t) total power real-time demand P_{energy storage total}(t) of battery energy storage station is calculated through the following formulation:

P_{energy storage total}(t)=P^{RL}_{w/p total}(t)−P_{w/p total}(t) (14)

D2) Based on the current sampling time (sampling time t) the maximum allowed charge and discharge power P^{MAD}_{energy storage total}(t) and P^{MAC}_{energy storage total}(t) of the battery station, the total power real-time demand computed through formulation (14) of battery energy storage station is corrected according to the following conditions:

If: P_{energy storage total}(t)>0 and P_{energy storage total}(t)>P^{MAD}_{energy storage total}(t), P_{energy storage total}(t)=P^{MAD}_{energy storage total}(t); (15)

If: P_{energy storage total}(t)<0 and |P_{energy storage total}(t)|>|P^{MAC}_{energy storage total}(t)|, P_{energy storage total}(t)=P^{MAC}_{energy storage total}(t) (16)

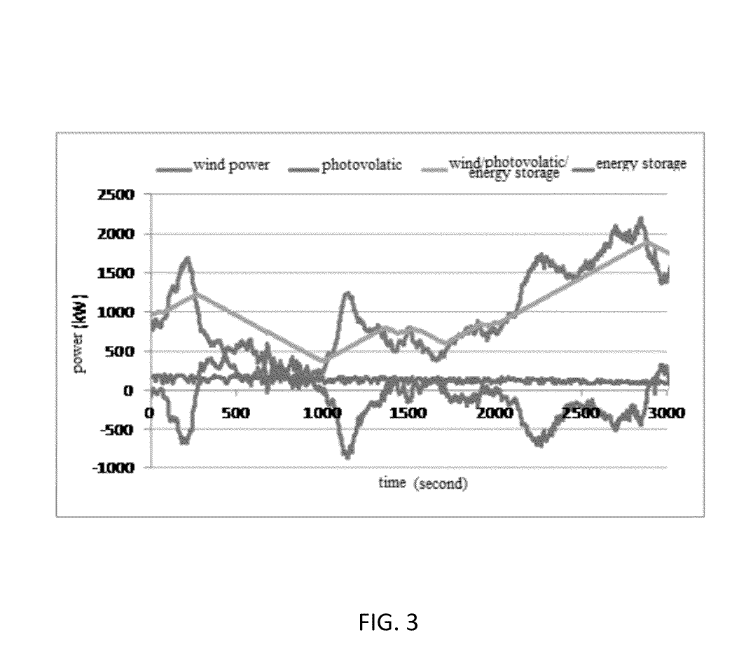

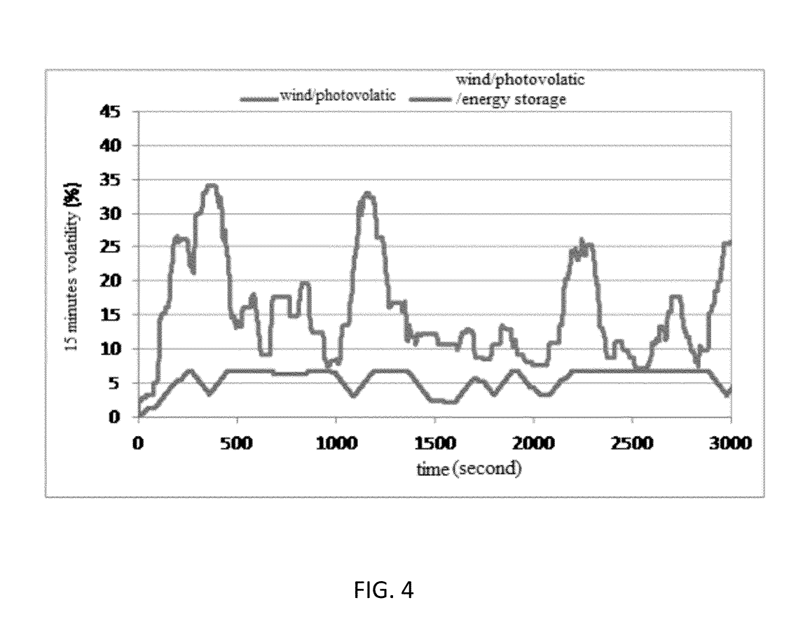

FIG. 3 is the control effect schematic diagram of smoothing wind and photovoltaic output power fluctuation based on energy storage power station provided by the invention. FIG. 4 is the fluctuation rate suppression effect schematic diagram of smoothing wind and photovoltaic output power fluctuation based on energy storage power station provided by the invention. The results shown in FIG. 3 and FIG. 4 are the rated power output fluctuation smoothing effect of the combined wind and photovoltaic power system in which the wind rated power is 3 MW and the photovoltaic rated power is 200 kW.

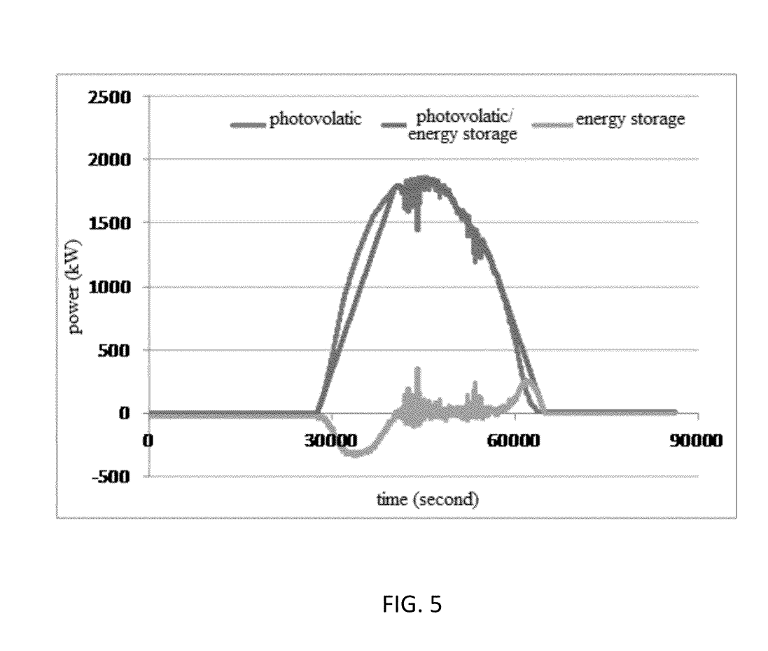

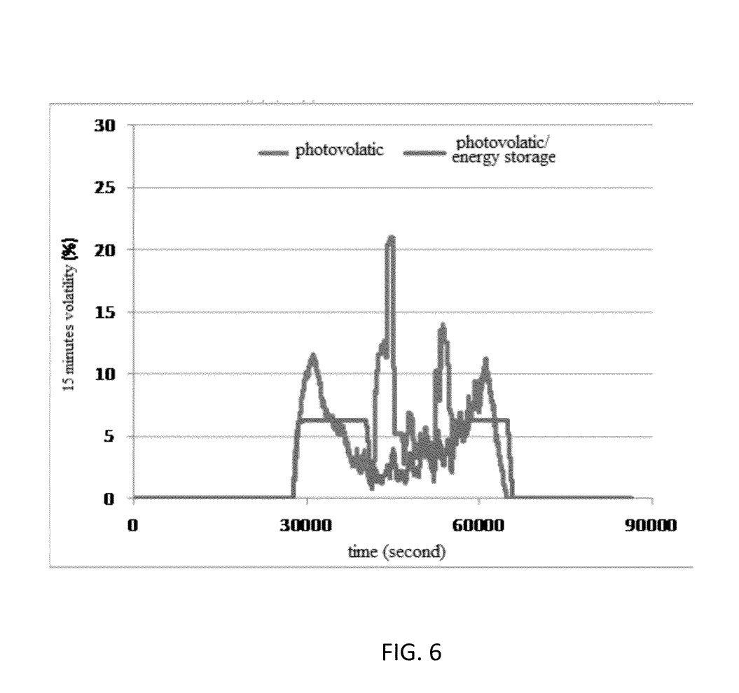

FIG. 5 is the control effect schematic diagram of smoothing photovoltaic output power fluctuation in one day based on energy storage power station provided by the invention. FIG. 6 is the fluctuation rate suppression effect schematic diagram of smoothing photovoltaic output power fluctuation in one day based on energy storage power station provided by the invention. The results shown in FIG. 5 and FIG. 5 are the rated power output fluctuation smoothing effect of the photovoltaic power system in which the photovoltaic rated power is 2000 kW.

From FIG. 3 to FIG. 6 can be seen, the method and system for smoothing the energy storage wind and photovoltaic power fluctuation control of based on rate control in the embodiment can effectively suppress wind and photovoltaic power fluctuation under the fluctuation rate limited value, can effectively smooth wind and photovoltaic power output. Thus it not only smooth wind and photovoltaic power output, also reduced effectively reduce the energy storage battery burden, and control battery energy storage power station system flexible and conveniently. It is easy to realize and master in the practical engineering application, can also meet the control requirement for the wind and photovoltaic and energy storage combined system smooth output power and the real time calculation requirement for large capacity MW battery energy storage power demand.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the art to understand the invention. It is intended that the scope of the invention be defined by the following claims and their equivalents.

What is claimed is:

1. A method for smoothing the wind and photovoltaic power fluctuation based on change rate, comprising:
A. reading relevant data of wind and photovoltaic power plant and battery energy storage power station, and save the relevant data, said wind and photovoltaic power plant including synchronized wind power generation units and photovoltaic units;
B. determining variability limited value of the wind and photovoltaic total power in real time;
C. calculating smoothing target value of the wind and photovoltaic total power in real time;
D. computing power demand value of the battery energy storage power plant in real time;
E. outputting the power demand value of the battery energy storage power plant calculated in step D and the smoothing target value of the wind and photovoltaic total power calculated in step C.

2. A control method according to claim 1, is characterized that, in step A, the said relevant data include: wind and photovoltaic power output fluctuation rate limited value, total power value of wind power plant, total power value of photovoltaic power plant, operation state values and rated power values of each wind unit in the wind power plant, operation state values and rated power values of each wind unit in the photovoltaic power plant, and maximum allowable charging power and the maximum allowable discharge power of the battery energy storage station.

3. A control method according to claim 2, is characterized that, said step B includes specific steps:
B1) calculating current total rated power of synchronized wind and photovoltaic power generation units, namely the wind and photovoltaic total rated power; and
B2) through the wind and photovoltaic total rated power, real-time calculating the change rate limited value of wind and photovoltaic total power.

4. A control method according to claim 3, is characterized that, in said step B1, the said wind and photovoltaic total rated power is calculated through below formulation:
$${P}_{w / p total}^{rated} = {\sum }_{k = 1}^{W} {u}_{wind k} {P}_{wind k}^{rated} + {\sum }_{k = 1}^{v} {u}_{photovolatic k} {P}_{photovolatic k}^{rated}$$
In which, P^{rated}_{wind k} is the rated power of the wind unit k; u_{wind k} is the operation status value of the wind unit k, when the unit k is in controllable operation, the value is equal to 1, or it is 0; P^{rated}_{photovolatic k} is rated power of the photovoltaic unit k; u_{photovolatic k} is the operation status value of the photovoltaic unit k, when the unit k is in controllable operation, the value is equal to 1, or it is 0; data above all are read through step A; W is the number of the wind units; and V is the number of the photovoltaic units.

5. A control method according to claim 3, is characterized that, in said step B2, the fluctuation rate limited value of wind and photovoltaic total power is calculated according to the following formulations:
$${k}_{rate}^{increase} = \frac{{P}_{w / p total}^{rated} \times {r}_{fluctuation rate}^{limited}}{{T}_{time}}$$
$${k}_{rate}^{decrease} = \frac{{P}_{w / p total}^{rated} \times {r}_{fluctuation rate}^{limited}}{{T}_{time}}$$
In which, k^{increase}ᵣₐₜₑ is the increasing rate limited value of wind and photovoltaic total power; k^{decrease}ᵣₐₜₑ is the decreasing rate limited value of wind and photovoltaic total power; r^{limited}_{fluctuation rate} is fluctuation rate limited value of wind and photovoltaic power, the value is read from step A; Tₜᵢₘₑ is the examine time interval of the change rate.

6. A control method according to claim 1, is characterized that, said step C includes the following specific steps:
C1) the first sampled wind and photovoltaic total power value, which is inputted to the dynamic slope limiter module, is set to the initial power output P^{RL}ₜₒₜₐₗ(l) after rate limiter;
C2) the current sampling time change rate of wind and photovoltaic total power value is computed based on below formulation:
$${r}_{rate}^{w / p total} ( t ) = \frac{{P}_{w / p total} ( t ) - {P}_{w / p total} ( t - 1 )}{Δ t} ( t \geq 2 )$$
In above formulation, P_{w/p total}(t), P_{w/p total}(t−1) are the wind and photovoltaic total power at the current sampling time t and the last sampling time of t−1, respectivly; said wind and photovoltaic total power is equal to the sum of the wind power and photovoltaic power; Δt is the sampling interval of wind and photovoltaic total power value;
C3) the judgment is made according to change rate limit condition, until get the power output P^{RL}_{w/p total}(t) after change rate limiter at current sampling time; save each power output after change rate limiter for the next sampling time judgment;
C4) the current output power P^{RL}_{w/p total}(t) after change rate limited is set as the current wind and photovoltaic total power smoothing target value P^{smooth target}_{w/p total}(t), i.e. P^{smooh target}_{w/p total}(t)=P^{RL}_{w/p total}(t).

7. A control method according to claim 6, is characterized that, specific judgment method according to said change rate limit condition in step C3 is:
If k^{decrease}ᵣₐₜₑ≦r^{w/p total}ᵣₐₜₑ(t)≦k^{increase}ᵣₐₜₑ, the output power P^{RL}_{w/p total}(t)=P_{w/p total}(t);
If r^{w/p total}ᵣₐₜₑ(t)>k^{increase}ᵣₐₜₑ, the output power P^{RL}_{w/p total}(t)=P^{RL}_{w/p total}(t−1)+Δt×k^{increase}ᵣₐₜₑ;
and
If r^{w/p total}ᵣₐₜₑ(t)<k^{decrease}ᵣₐₜₑ, the output power P^{RL}_{w/p total}(t)=P^{RL}_{w/p total}(t−1)+Δt×k^{decrease}ᵣₐₜₑ.
In which, P^{RL}_{w/p total}(t) is the power output of dynamic slope limiter module after change rate limiter at current sampling time t; P^{RL}_{w/p total}(t−1) is the power output of dynamic slope limiter module after change rate limiter at previous sampling time.

8. A control method according to claim 1, is characterized that, the specific step of said step D includes:
D1) taking the difference between the current sampling time output power P^{RL}_{w/p total}(t) got from step C and current sampling time wind and photovoltaic total power value P_{w/p total}(t) as the current sampling time total power real-time demand P_{energy storage total} (t) of battery energy storage station;
D2) according to current sampling time t the maximum allowed charge and discharge power of the battery station, correcting the current total power real-time demand P_{energy storage total}(t) of battery energy storage station.

9. A control method according to claim 8, is characterized that, the specific correction method of the said P_{energy storage total}(t) includes:
If P_{energy storage total}(t)>0 and P_{energy storage total}(t)>P^{MAD}_{energy storage total}(t), P_{energy storage total}(t)=P^{MAD}_{energy storage total}(t);
If P_{energy storage total}(t)<0 and |P_{energy storage total}(t)|>|P^{MAC}_{energy storage total}(t)|, P_{energy storage total}(t)>P^{MAC}_{energy storage total}(t).

10. A system for smoothing the energy storage wind and photovoltaic power fluctuation control of based on rate control, is characterized that the system includes:
the communication module is used for data receiving the relevant data of wind and photovoltaic power plant and battery energy storage power station, and data transmission and communication with external monitoring platform;
the data storage and management module is used for data storage and management of wind and photovoltaic power plant and battery energy storage power station; and sends the smoothing target value of the wind and photovoltaic total power calculated and real time total power demand value of the battery energy storage power station to the external monitoring platform;
the limited change rate calculation module is used for determining real time change rate limited value of wind and photovoltaic total power, and sends to the dynamic slope limiter module;
the dynamic slope limiter module is used for calculating real-time smoothing target value of the wind and photovoltaic total power; and
the power distribution controller module is used for real-time calculation of real-time total power demand value of battery energy storage power station.
